(19) United States
(12) Patent Application Publication
(10) Pub. No.: US 2025/0369747 A1
(43) Pub. Date: Dec. 4, 2025

(54) MEASURING MACHINE

(71) Applicant: Carl Mahr Holding GmbH, Goettingen (DE)

(72) Inventor: Michael STAATS, Nörten-Hardenberg (DE)

(21) Appl. No.: 19/224,956

(22) Filed: Jun. 2, 2025

(30) Foreign Application Priority Data
Jun. 3, 2024 (DE) 10 2024 115 312.1

(51) Int. Cl. G01B 11/00

(52) U.S. Cl. CPC G01B 11/007

(57) ABSTRACT

A measuring machine having at least one translational or rotational machine axis in order to move and/or position a workpiece holder and a workpiece measuring unit relative to one another. The at least one machine axis has for this purpose a positioning body, which is movably supported in a translational or rotational movement degree of freedom on an assigned guide and on which a sensor support is supported via a support arrangement. The support arrangement is configured to provide a statically determined support of the sensor support on the positioning body and to concurrently provide a tensionless support. In this manner it is avoided that torsions or other deformations of the positioning body occur to the sensor support, the workpiece holder and the workpiece measuring unit.

### CROSS REFERENCE TO RELATED APPLICATION

This application claims the benefit of German Patent Application No. 10 2024 115 312.1, filed Jun. 3, 2024, which is incorporated herein by reference in its entirety.

### TECHNICAL FIELD

The invention refers to a measuring machine that is configured to measure a workpiece by means of a workpiece measuring unit and to thereby create a measurement signal. Based on the measurement signal and using additional sensor signals, a measurement value can be determined. Thereby it is in general desirable to achieve a measurement value determination that is as exact as possible.

### BACKGROUND

DE 197 11 500 A1 describes a measurement system for automatic determination and correction of position deviations in order to carry out the measurement of components that move relative to one another independent from thermal influences, in that probe devices probing a scale or measuring a rod for position determination are directly or indirectly assigned to a solid measure or form.

From DE 43 45 094 A1 a form measuring machine having a measuring arm is known, at the end of which a form measuring sensor is arranged. The measuring arm is arranged on a movable slide. A reference system is formed from three normals, in order to be able to determine the position of the probe unit in the space.

For calibrating a coordinate measuring apparatus by means of a reference body, DE 10 2008 024 444 A1 proposes to probe the reference body at multiple measuring points to determine therefrom, axis fault values of the coordinate measuring apparatus of the coordinate axis to be calibrated.

A reference arrangement for a coordinate measuring apparatus having at least one linear axis is known from DE 10 2019 134 940 A1. By means of the reference arrangement, a reference body can be moved along a guide, wherein the reference body defines a reference point. This reference point can be determined as reference value.

In DE 10 2013 102 477 A1 a positioning device for a positioning table is described, wherein a sensor arrangement is provided for determination of the position of the positioning table. The sensor arrangement can operate optically, for example, and can emit light on a code plate and detect a light pattern created by the code plate in a photo receiver and evaluate it for position determination.

In DE 2 008 813 A1 a compensation device and a compensation method for a measuring head of a measuring machine are described in order to compensate, for example, temperature-based influences. For this purpose, a temperature-based scale change relative to a thermally uninfluenced rod is determined and can be compensated in this manner.

Such a method is also described in DE 10 2014 016 646 A1.

A temperature-compensated gauge scale according to DE 197 261 73 A1 comprises two rods with different thermal expansion coefficients that are immovably arranged in a plane. On these rods, levers are arranged that extend orthogonal to the rods and, due to the different thermal coefficients of the rods, the orientation of the levers is maintained. In another embodiment, rods made of aluminum are attached on a base plate of steel and are in turn coupled at one end with additional rods made of steel. Hereby, the effect is used that aluminum has a double temperature extension compared to steel, so that the temperature expansion of the aluminum rod relative to the temperature expansion of the steel rod and the base plate is approximately eliminated.

A device for holding measuring instruments, for example, interferometers, is known from DE 102 59 186 A1. The holder consists of a material with very low thermal expansion coefficients, for example, glass ceramic or a metal alloy.

DE 34 47 162 A1 discloses an axial bearing for a threaded spindle having a ball that is arranged between two support surfaces that are orientated orthogonal to the axial direction, wherein the ball is supported in a sleeve so that it can roll on the support surfaces.

### SUMMARY

Starting from this prior art, it can be considered as one object of the present invention to improve a measuring machine and to particularly increase the measuring accuracy.

This object is solved by means of a measuring machine as disclosed herein.

The measuring machine, according to the present invention, is configured to determine a measurement value of a workpiece. For this purpose, the measuring machine comprises a workpiece holder for holding the workpiece as well as a workpiece measuring unit by means of which a workpiece can be probed with contact or in a contactless manner and thereby at least one measurement signal can be created.

The workpiece measuring unit can be designed differently depending on the measurement task. For example, a workpiece measuring unit of one type can have a probe with which the workpiece can be probed in contacting manner. A workpiece measuring unit of another type can operate contactless and can for this purpose comprise one or more optical measuring devices, for example a light source and a camera. An optical measurement can be carried out, for example in transmitted light or reflected light. Also, a scanner, particularly a laser scanner, contactless operating distance sensors or the like can be used in a workpiece measuring unit.

The measuring machine is configured to move or position the workpiece holder and the workpiece measuring unit relative to one another in order to probe the workpiece at one or multiple measuring positions. For this purpose, the measuring machine comprises at least one measuring axis that can be denoted as first machine axis. The first machine axis has a first positioning body and a first guide on which the first measuring body is moveably supported in a first movement degree of freedom and can be positioned in this first movement degree of freedom. The first movement degree of freedom can be a translational or rotational degree of freedom.

In order to be able to carry out the relative positioning between the workpiece holder or a workpiece held on the workpiece holder and the workpiece measuring unit, the workpiece holder or the workpiece measuring unit can be directly or indirectly arranged on the first positioning body. For example, the workpiece measuring unit can be in movement coupling with the first positioning body while the workpiece holder is moveable by means of another machine axis relative to a machine base or is immovably arranged relative to the machine base. The first machine axis having the first positioning body can be alternatively used to move and position the workpiece holder.

The measuring machine has additionally a first position sensor that is configured to detect the relative movement and/or relative position between the first positioning body and the first guide. For example, a first scale can be arranged on the first guide and can be immovably arranged relative to the first guide and the first position sensor can be arranged on the first positioning body. The position sensor and the scale can cooperate in order to detect a movement and/or a position of the first positioning body in the first movement degree of freedom.

The measuring machine according to the present invention further comprises a sensor support. The first position sensor is arranged on the sensor support. The sensor support in turn is supported on the first positioning body by means of a support arrangement. By means of the support arrangement, the sensor support is supported on the positioning body in a statically determined manner. For example, for a statically determined support in all spatial degrees of freedom (three translational and three rotational degrees of freedom) six support points or support positions are present. Preferably, one separate, individual support unit is present for each spatial degree of freedom. The support arrangement is configured in a manner so that each degree of freedom is separately supported without play, but without providing a support in any other degree of freedom. Each of the spatial degrees of freedom is respectively supported by means of a fixed bearing in this degree of freedom and by means of a floating bearing or in a floating manner in all other spatial degrees of freedom. The sensor support is thus supported on the first positioning body in a statically exactly determined manner and in a stressless or floating manner.

Due to the stressless or floating support of the sensor support on the first positioning body, it is avoided that tensions or torsions of the first positioning body result in an undefined deformation of the sensor support and thus to an undefined position of the first position sensor. The floating support has the effect that movements or deformations of the first positioning body result respectively in a movement of the sensor support that can be detected by measurement. In this manner it is possible to carry out the measurement of the movement and/or the position of the first positioning body in the first movement degree of freedom by means of the first position sensor with high accuracy.

The measuring machine can comprise a machine base. The machine base defines a machine coordinate system. The first guide can be immovably arranged relative to the machine coordinate system.

In an embodiment, the first guide can be immovably arranged on the machine base and can extend along the first movement degree of freedom away from the machine base, for example linearly. The first guide can be arranged on a-preferably vertical-guide column. On such a guide column, the first scale can be arranged with which the first position sensor cooperates, for example.

It is preferred if at least one reference sensor group, having at least one reference sensor respectively, is arranged on the sensor support. The at least one reference sensor can be a distance sensor and can be configured to detect a distance and/or a distance change relative to a measurement surface.

If the reference sensor group comprises multiple reference sensors arranged with distance to one another that detect the distance and/or distance change relative to the same measurement surface, also rotational movements and/or tilting movements of the sensor support relative to the measurement surface can be detected around one or more axes that are orientated parallel to the measurement surface.

A measurement surface can be a reference surface or a datum surface. In the embodiment described here, the reference surface is a measurement surface that is immovably arranged relative to the machine coordinate system, and a datum surface is a measurement surface, which is movable relative to the machine coordinate system, which can be arranged, for example, on a movably supported component (particularly positioning body) of one of the provided machine axes.

In an embodiment, a first reference sensor group is provided on the sensor support, wherein each reference sensor of the first reference sensor group is configured to detect a distance and/or a distance change of the sensor support relative to a first reference surface. The first reference surface is orientated parallel to the first movement degree of freedom and is arranged immovably relative to the first guide, for example, on the machine base or guide column. The distance or distance change is detected orthogonal to the first reference surface and thus orthogonal to the first movement degree of freedom. Particularly, the distance or distance change can be detected by each reference sensor of the first reference sensor group in a second movement degree of freedom of a second positioning body of the measuring machine.

If the first movement degree of freedom is a rotational degree of freedom, the first reference surface extends in circumferential direction around the rotation axis of this rotational first movement degree of freedom. Thereby, the first reference surface can be orientated in a direction parallel to the rotation axis (axial direction) and/or in a direction radial to the rotation axis (radial direction). A normal vector of the first reference surface can define an arbitrary angle with the rotation axis from 0° up to 360°.

In an embodiment, the first reference sensor group comprises two reference sensors that are arranged with distance to one another in the direction of the first movement degree of freedom and are preferably arranged along an axis that extends parallel to the first movement degree of freedom.

Preferably, the at least one reference sensor of the first reference sensor group and the first position sensor measure in a common plane in which the first reference surface is arranged. For example, for this purpose, the first scale can be arranged in the same plane as the first reference surface.

It is additionally advantageous if a second reference sensor group is arranged on the sensor support. The second reference sensor group comprises at least one reference sensor that is configured to detect a distance and/or a distance change of the sensor support to one or more measurement surfaces, particularly to a second reference surface. Preferably, the first reference surface and the second reference surface are orientated orthogonal to one another. By means of each reference sensor of the second reference sensor group, a distance and/or a translational movement of the sensor support can be detected in a direction orthogonal to the second reference surface. If the second reference sensor group comprises multiple reference sensors, also a tilting movement around one or more axes can be detected that are orientated parallel to the second reference surface.

In an embodiment, the second reference sensor group comprises three reference sensors that are arranged with distance to one another in a plane parallel to the at least one assigned measurement surface, in a triangular form so-to-speak, so that only two of the three reference sensors are arranged along a common straight line respectively.

In a preferred embodiment of the measuring machine, a second machine axis is provided, having a second positioning body and a second guide. The second positioning body is movably supported on the second guide in a translational or rotational second movement degree of freedom and can be positioned in the second movement degree of freedom. The second guide is arranged on the first positioning body. For example, in doing so, a cross slide can be formed or a combined lift-and-rotation axis or similar.

A second position sensor detects a movement and/or position of the second positioning body in the second movement degree of freedom and is for this purpose arranged on the sensor support. Particularly, the second position sensor can cooperate with a second scale that is arranged immovably relative to the second positioning body on the second positioning body.

The first movement degree of freedom and the second movement degree of freedom are different from one another and can be, for example, translational degrees of freedom that are orientated orthogonal to one another. In another embodiment, the first movement degree of freedom can be a translational degree of freedom and the second movement degree of freedom can be a rotational degree of freedom or vice versa.

It is advantageous, if the measuring machine further comprises a third machine axis having a third positioning body and a third guide. The third positioning body can be movably supported on the third guide parallel to the second positioning body in the second movement degree of freedom and can be positioned in the second movement degree of freedom. Analog to the second positioning body, also the third guide for the third positioning body can be arranged on the first positioning body. By means of a third position sensor, a movement and/or a position of the third positioning body can be detected in the second movement degree of freedom. The third position sensor is therefore arranged on the sensor support. Particularly, the third position sensor can cooperate with a third scale that is immovably arranged relative to the third positioning body on the third positioning body.

On the second positioning body and/or on the third positioning body, a first datum surface can be arranged relative to which the at least one first reference sensor of the second reference sensor group detects a distance and/or distance change. A first datum surface provided on the second positioning body and the second scale and/or a first datum surface provided on the third positioning body and the third scale can be arranged in one common plane, respectively.

In an advantageous configuration of the measuring machine, in addition, a third reference sensor group having at least one reference sensor can be provided and arranged on the sensor support. Each reference sensor of the third reference sensor group is configured to detect a distance and/or distance change of the sensor support to a second datum surface arranged on the second positioning body. Additionally or alternatively, each reference sensor of the third reference sensor group can be configured to detect a distance and/or distance change of the sensor support to a third datum surface arranged on the third positioning body.

The second datum surface and/or the third datum surface is/are orientated parallel to the second movement degree of freedom and preferably orthogonal to the first movement degree of freedom.

It is advantageous if each reference sensor comprises at least one sensor element that is arranged in a sensor housing. The sensor housing is attached at an attachment position on the sensor support. Each sensor element has a sensor surface facing the assigned measurement surface (reference surface or datum surface). Originating from the attachment position up to the sensor surface or up to one of the sensor surfaces, the sensor housing has the same thermal longitudinal expansion as the at least one component of the measuring machine that connects the attachment position on the sensor support and the measurement surface assigned to the sensor element. This at least one component is a part of the sensor support on one hand, on which the attachment position is located, and optionally—if present—at least one adjoining holding or guide component of one of the present machine axes. The sensor housing thus expands between the attachment position and the sensor surface about the same amount as the components or parts that connect the attachment position and the measurement surface (reference surface or datum surface) with one another. In this manner, thermal influences can be eliminated partly or entirely. The measurement of the distance or distance change is thus substantially free from thermal influences.

One, more or all reference sensors of a reference sensor group or multiple reference sensor groups can comprise two sensor elements in an embodiment, which can be denoted as first sensor element and as second sensor element. Each of the sensor elements is configured to detect a distance and/or distance change to an assigned measurement surface (reference surface or datum surface), wherein the sensor surfaces of the first and second sensor element of a common reference sensor are thereby orientated in opposite measurement directions. In doing so, a distance between the measurement surfaces can be determined, for example between a datum surface and a reference surface.

In an embodiment of a reference sensor having two sensor elements the sensor housing can be configured so that the distance between the sensor surfaces of the two sensor elements is at least substantially constant if subject to thermal influences.

In a preferred embodiment, this thermal insensitivity of the sensor housing can be achieved in that the sensor housing comprises multiple housing parts that are expandable relative to one another, for example housing sleeves that are at least substantially coaxially arranged relative to one another. The longitudinal expansion of these housing parts is selected so that their longitudinal expansions eliminate one another at least substantially. Particularly for this purpose, two directly adjacent housing parts can be rigidly connected with one another at one end while they are supported freely moveably relative to one another at the opposite end and thus are able to expand relative to one another in their lengths due to thermal influences. Thereby, the first sensor part is attached on one housing part and the second sensor element is attached on the other housing part. The number of housing parts that connect the first sensor element with the second sensor element can be an odd number, for example three housing parts can be present. Thereby, a middle housing part can have a thermal expansion coefficient that is twice compared to the thermal expansion coefficient of an inner housing part attached thereto at one end and an outer housing part attached thereto at the respective other end. For example, the inner and the outer housing part can consist of steel or a steel alloy and the middle housing part can consist of aluminum or an aluminum alloy.

The measuring machine can have a control device that is configured, for example, to move or position one or more positioning bodies in the respective movement degree of freedom.

The control device can also be communicatively connected with the workpiece measuring unit so that the at least one measurement signal of the workpiece measuring unit is available by the control device. The control device can also be communicatively connected with the at least one present position sensor and the at least one present reference sensor, so that additionally the at least one position signal and the at least one reference sensor signal are available for the control device. The control device is configured to determine a measurement value from the at least one measurement signal, the at least one reference sensor signal and the at least one position sensor signal, wherein the measurement value characterizes the workpiece at the measurement position at which the respective at least one measurement signal has been created. The measurement value can be, for example, a position in a machine coordinate system of the measuring machine that indicates a characteristic point of a surface and/or an edge. The at least one position signal and the at least one reference sensor signal can be combined in order to achieve a higher accuracy of the measurement value, as it would be possible by the at least one position signal solely.

The support arrangement for supporting the sensor support on the first positioning body has preferably multiple separate support units, particularly six support units. Each support unit is configured to support the sensor support and the first positioning body in exactly one spatial direction, which can be denoted as bearing or support direction. Each support unit is configured to allow relative movements orthogonal to this bearing or support direction in a substantially unimpeded manner.

In an embodiment, each support unit comprises a rolling element, for example a ball, and preferably exactly one rolling element. The rolling element is supported at a support position on the sensor support and at another support position on the first positioning body. The two support positions define a straight line that extends preferably through the center point or the center axis of the rolling element. The support positions can be located diametrically opposite to one another relative to the center point or the center axis.

It is preferred if each rolling element is arranged in an elastically deformable support sleeve. In case of a force influence obliquely or orthogonal relative to the straight line, on which the support positions are located, the rolling element of the respective support unit can roll between the sensor support and the first positioning body, so that each support unit is only able to support a force along the straight line on which the support positions are located.

Particularly, the elastically deformable support sleeve is configured so that a static friction and/or a dynamic friction between the rolling element and the support sleeve is lower than a rolling start resistance and/or a rolling resistance of the rolling element at the support positions. In order to achieve this, the support sleeve can consist of a suitable material, for example a soft porous material, such as a foamed material, that provides a material pairing with the material of the rolling element that guarantees a sufficiently small static or dynamic friction. The rolling element preferably consists of steel or a steel alloy.

Multiple support units of the support arrangement can be arranged along a common first plane, so that each support unit has one support position in this first plane. For example, three support units can have one support position respectively in the first plane. In an embodiment, the first plane is orientated parallel to the first movement degree of freedom and/or to the second movement degree of freedom.

Additionally or alternatively, multiple support units can have a support position in a common second plane respectively. The second plane can be orientated orthogonal to the first plane. For example, the second plane is orientated orthogonal to the first movement degree of freedom.

In a direction orthogonal to the first plane and orthogonal to the second plane, one and particularly exactly one support unit can be provided. The support positions of this support unit are located on a straight line that is orientated orthogonal to the first plane or orthogonal to the second plane and can be, for example, orientated parallel to the first movement degree of freedom.

In this description the numbers that precede an object, such as “first” or “second” or “third”, etc. only serve the purpose for distinction of the objects from one another and particularly do not comprise any sequence or priority as long as it is not explicitly mentioned. For example, a first positioning body and a third positioning body can be present without requiring a second positioning body. The same applies also for other objects that are distinguished from each other in this manner.

### BRIEF DESCRIPTION OF THE DRAWINGS

Advantageous embodiments of the invention are derived from the dependent claims the description and the drawing. In the following, preferred embodiments are explained in detail based on the attached drawing. The drawing shows:

FIG. 1 a perspective schematic illustration of an embodiment of a measuring machine,

FIG. 2 a schematic basic illustration of multiple positioning bodies that are respectively movably supported in a linear movement degree of freedom on a guide as well as a sensor support, arranged on a first positioning body by means of a support arrangement,

FIG. 3 the schematic illustration of FIG. 2 with view in another direction,

FIG. 4 a perspective illustration of an embodiment of a sensor support of FIGS. 1 and 2 in a first view,

FIG. 5 the embodiment of the sensor support of FIG. 4 in another perspective illustration,

FIG. 6 an illustration in part of an embodiment of the measuring machine in a cutting plane parallel to a first movement degree of freedom and orthogonal to a second movement degree of freedom, wherein multiple positioning bodies as well as the sensor support and reference sensors arranged thereon are apparent,

FIG. 7 a basic illustration of a support unit of the support arrangement for support of the sensor support on the first positioning body,

FIG. 8 a basic illustration of an embodiment of a reference sensor in a thermally insensitive arrangement and configuration,

FIGS. 9 and 10 a longitudinal cut through an embodiment of a reference sensor having two sensor elements,

FIG. 11 a perspective illustration of an embodiment of a rotary table having a workpiece holder, wherein the rotary table comprises a first positioning body that can be moved and positioned in a rotational first degree of freedom around the rotation axis,

FIG. 12 a cut illustration through the rotary table of FIG. 11 in a cutting plane along the rotation axis,

FIG. 13 a basic illustration of a sensor support for the rotary table of FIGS. 11 and 12, and

FIG. 14 a basic illustration of an embodiment for arrangement of reference sensors on the rotary table according to FIGS. 11 and 12.

### DETAILED DESCRIPTION

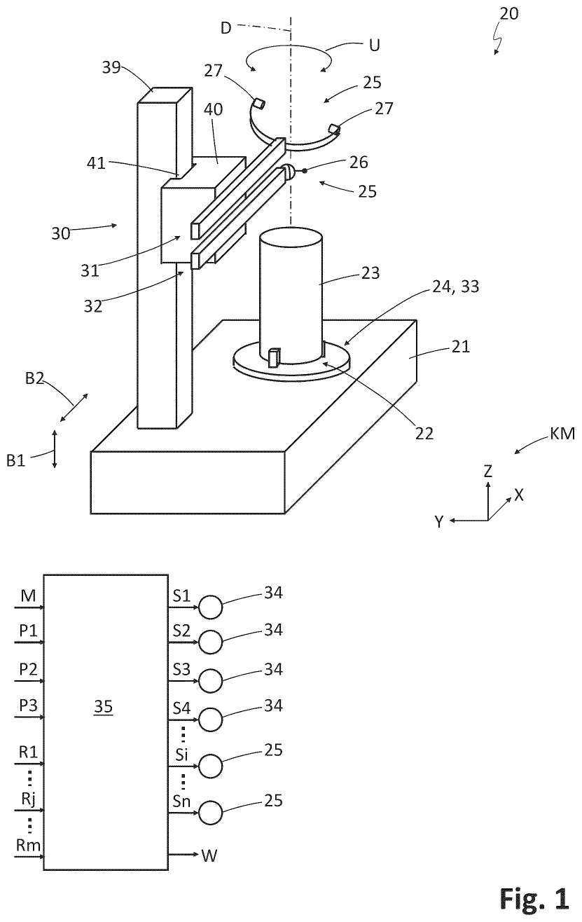

FIG. 1 shows a measuring machine 20 in a perspective simplified illustration. The measuring machine 20 has a machine base 21, wherein a machine coordinate system KM is defined to be immovably fixated relative to the machine base 21. The machine coordinate system KM can be a Cartesian coordinate system, for example, having an X-direction, a Y-direction and a Z-direction.

The measuring machine 20 has a workpiece holder 22 for a workpiece 23. The workpiece holder 22 can comprise clamping devices for clamping of the workpiece 23 or other support or clamping parts. It is configured to hold the workpiece 23 during measurement and as an option to move the workpiece 23. For this purpose, the workpiece holder 22 can comprise a rotary table 24 that is rotatable around a rotation axis D, for example.

Measuring machine 20 comprises additionally at least one workpiece measuring unit 25. In the embodiment schematically illustrated in FIG. 1, measuring machine 20 can have two different workpiece measuring units 25. Each workpiece measuring unit 25 is configured to create at least one measurement signal M during probing of the workpiece 23. The probing of the workpiece 23 at a measurement position on the workpiece surface can be carried out in a contacting manner, for example, using a tactile probe 26 of a workpiece measuring unit 25, or in a contactless manner. For contactless probing, a workpiece measuring unit 25 can comprise at least one optical measurement device 27, for example, such as a light source and a light receiver (for example a camera). Such an optical measurement device 27 can operate with transmission light, as schematically illustrated in FIG. 1, and/or can alternatively be configured for measurement value detection with reflected light. Also, other contactless operating workpiece measuring units 25 can be used, such as scanner, particularly laser scanner, or measuring devices that operate in capacitive and/or inductive manner.

For relative movement and/or relative positioning of the at least one workpiece measuring unit 25 relative to the workpiece holder 22 or a workpiece 23 held therein, the measuring machine 20 comprises at least one and in the embodiment multiple machine axes that can carry out a movement and/or positioning in a translational or rotational degree of freedom in each case. Thereby a measuring axis can move and/or position a workpiece measuring unit 25 relative to machine base 21 or it can move and/or position the workpiece holder 22 or the workpiece 23 relative to machine base 21. Such machine axes can be combined with one another in arbitrary manner.

In the embodiment of the measuring machine 20 according to FIG. 1, at least two or three translational machine axes and a rotational machine axis are provided. For example, a first machine axis 30 is a translational machine axis in Z-direction, a second machine axis 31 is a translational machine axis in X-direction and a third machine axis 32 is another translational machine axis in X-direction. A fourth machine axis 33 provided according to the example is a rotational machine axis in a circumferential direction U around a rotation axis D. According to the example, the rotation axis D extends in Z-direction. In the embodiment, the Z-direction of measuring machine 20 according to FIG. 1 is a vertical direction.

In a modified embodiment, the measuring machine 20 could also have a different combination of machine axes. For example, optionally additionally, a translational machine axis in Y-direction could be provided. Basically, one of the two machine axes in X-direction could be omitted.

Each machine axis 30 to 33 has a guide extending in the respective movement degree of freedom, along which an assigned positioning body can be positioned and can be moved in a guided manner. For movement and positioning, each machine axis 30 to 33 has an assigned axis drive 34. The axis drives 34 are illustrated in FIG. 1 only schematically in the type of a block diagram and can respectively comprise an electric motor. By means of a control device 35, the axis drives 34 can be individually controlled by means of an assigned control signal Si (i=1, 2, 3, . . . n). Also, additional drives for the at least one workpiece measuring unit 25—if present—can be controlled by means of a respective control signal Si of control device 35.

A measurement signal M of the at least one workpiece measuring unit 25 is additionally provided to control device 35. Together with additional sensor values, the control device 35 can determine a measurement value W therefrom, that can be, for example, indicated via an interface of measuring machine 20 and/or stored and/or transmitted to an external computing or memory unit. The measurement value W can preferably be a position value that can also be used for an optimized/corrected positioning of the workpiece measuring unit 25 in addition to a determination and/or evaluation of the workpiece 23 describing value.

The measuring machine 20 can comprise a guide column 39 extending from machine base 21, for example in Z-direction. In a operation position of measuring machine 20, the Z-direction can be orientated vertically.

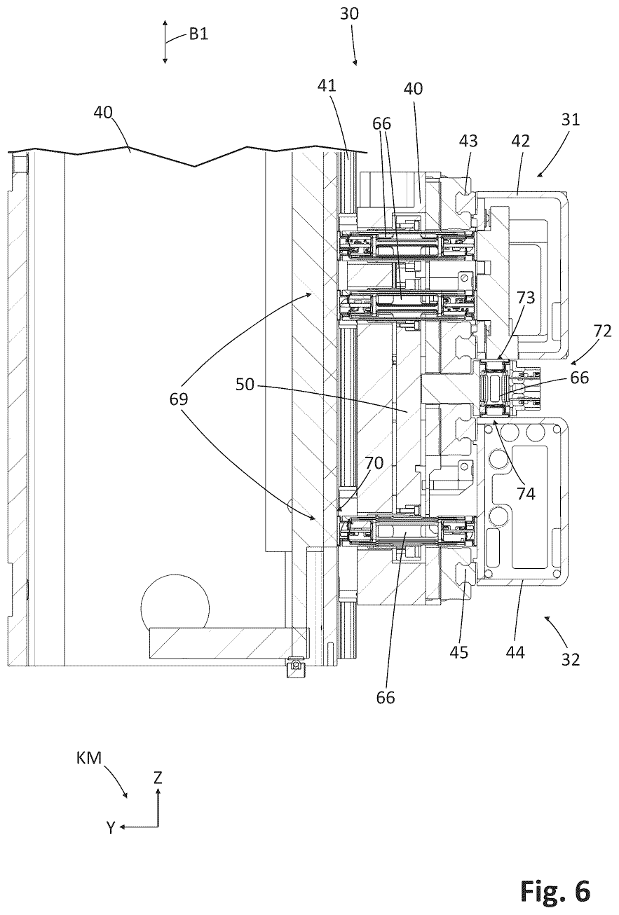

In the embodiment, the first machine axis 30 has a first positioning body 40 that is supported in movable and positionable manner along a first guide 41 in a first translational movement degree of freedom B1 (FIGS. 1-3 and 6). Analog to this, second machine axis 31 has a second positioning body 42 that is supported in movable and positionable manner along a second guide 43 in a translational second movement degree of freedom B2. The third machine axis 32 has a third positioning body 44 that is supported in a movable and positionable manner along a third guide 45 in the translational second movement degree of freedom B2.

According to the example, first guide 31 is immovably arranged relative to machine base 21 or machine coordinate system KM on guide column 39.

The first movement degree of freedom B1 is orientated in Z-direction in the embodiment, while second movement degree of freedom B2 is orientated in X-direction. Second guide 43 and third guide 45 are arranged on first positioning body 40. The second positioning body 42 and the third positioning body 44 support one workpiece measuring unit 25 respectively that can be moved and positioned in this manner in the first movement degree of freedom B1 and the second movement degree of freedom B2 relative to machine base 21 in each case.

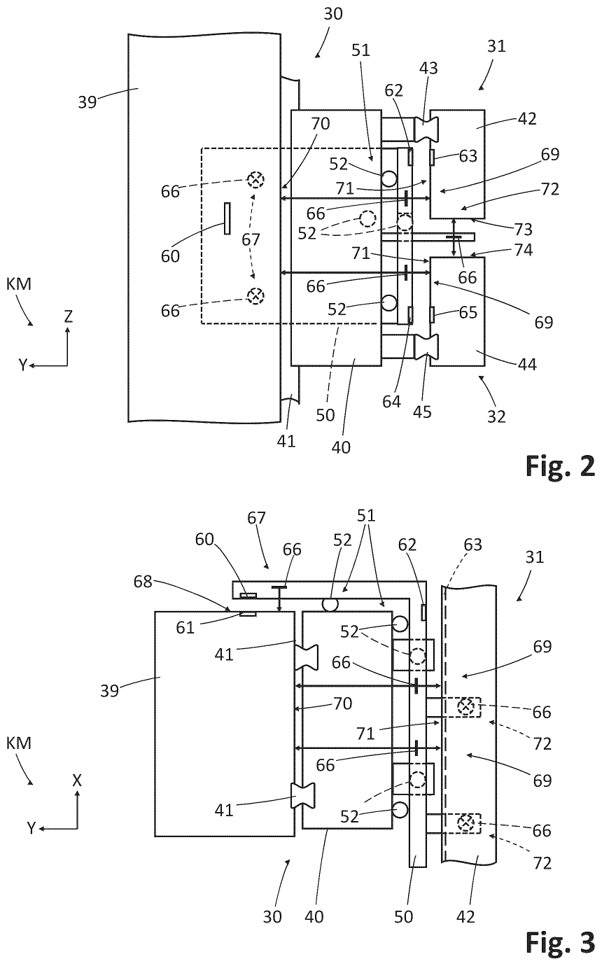

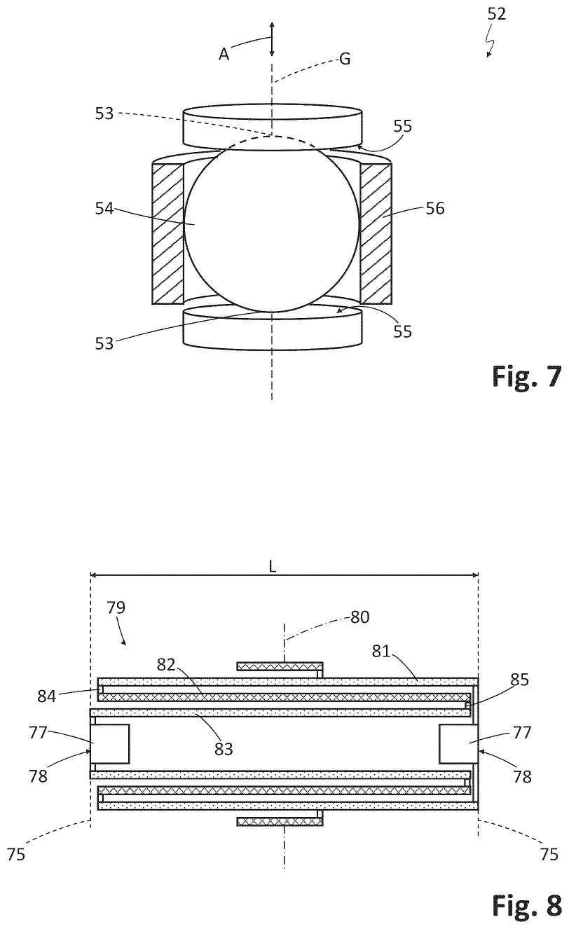

The measuring machine 20 comprises a sensor support 50 that is supported by means of a support arrangement 51 on first positioning body 40 (FIGS. 2-6). The support arrangement 51 is configured to support sensor support 50 in a statically determined manner on first positioning body 40. The position of sensor support 50 relative to the first positioning body 40 is thus defined in all of the degrees of freedom in the machine coordinate system KM. For this purpose, the support arrangement 51 comprises multiple and according to the example six support points or support positions between the first positioning body 40 and sensor support 50, wherein each support point or each support position is realized by means of one support unit 52 of the support arrangement 51. The support units 52 are schematically indicated by spheres or circles in FIGS. 2 and 3. An embodiment of a support unit 52 is illustrated in FIG. 7.

Each support unit 52 of support arrangement 51 supports sensor support 50 on the first positioning body 40 in only one support direction A, that is in one single degree of freedom. The support direction A extends along a straight line G between two support positions 53 of the support unit 52. The support unit 52 can only support forces that are effective along the straight line G between the support positions 53. Forces applied obliquely or orthogonal to this straight line G on support unit 52 are not supported by support unit 52.

In a support position or in at least one of the support units 52, a not shown force creation device can be provided (such as an elastically compressible body and/or a spring and/or a magnet, etc.) that is configured to create a holding force. The force creating device can be arranged concentrically around the support direction A, for example. The holding force can be effective centrically along the support direction A in an aligned manner. This force creation device does not have to be provided in each support position or support unit 52. Preferably at least one force creating device is present, the holding force of which acts in a horizontal direction of the machine coordinate system KM, for example, a force creating device for a holding force in X-direction and/or a force creating device for a holding force in Y-direction of the machine coordinate system KM. A force creating device for a holding force that acts in Z-direction of the machine coordinate system KM, which is a vertical direction according to the embodiment, can be provided as an option, but this holding force can alternatively also be created by means of the force of gravity.

In the embodiment, the support unit 52 has exactly one rolling element 54 that is preferably configured as a ball. The rolling element 54 abuts at each support position 53 against support surface 55. The distance of the support surfaces 55 in support direction A or the distance of the support positions 53 in support direction A corresponds to the ball diameter in the embodiment and is particularly constant. The straight line G extends through the center point of the ball according to the example.

One of the support surfaces 55 is arranged on the sensor support 50 and the other support surface 55 is arranged on the first positioning body 40. The support surfaces 55 can thereby be arranged on a separate support body or can be integral or monolithic part of sensor support 50 or the first positioning body 40 respectively.

In the embodiment, the ball or the rolling element 54 consists of steel or a steel alloy or another metalic alloy. The support surfaces 55 consist preferably also of steel or a steel alloy or a metalic alloy.

The rolling element 54, which is spherical according to the invention, can roll orthogonal to the support direction A between the two support surfaces 55. Thus, each of the support units 52 allows a relative movement between sensor support 50 and the first positioning body 40 in all of the directions that are orientated orthogonal to the respective support direction A.

As depicted in FIG. 7, a support sleeve 56 can be provided for supporting the rolling element 54. The support sleeve 56 surrounds the rolling element 54 in a circumferential direction around the straight line G. The support sleeve 56 is elastic according to the example. It can be elastically deformed during rolling of the spherical rolling element 54 by means of the forces that occur thereby. For example, the support sleeve 56 can consist of a foam material. On its outer side, facing away from rolling element 54, support sleeve 56 can be directly or indirectly supported on sensor support 50 or on first positioning body 40.

The material pairing between the material of the support sleeve 56 and the material of rolling element 54 and/or the elasticity of support sleeve 56 is selected so that the static friction and the dynamic friction between the support sleeve 56 and the rolling element 54 is lower than the static rolling start resistance and the dynamic rolling resistance of rolling element 54 on the support surfaces 55. Thereby it is guaranteed that the support sleeve 56 does not block rolling of the rolling element 54 between the support surfaces 55 and influences such rolling only in negligible manner. The occurring forces acting on the support unit 52, the configuration is of a type that rolling element 54 is always able to roll.

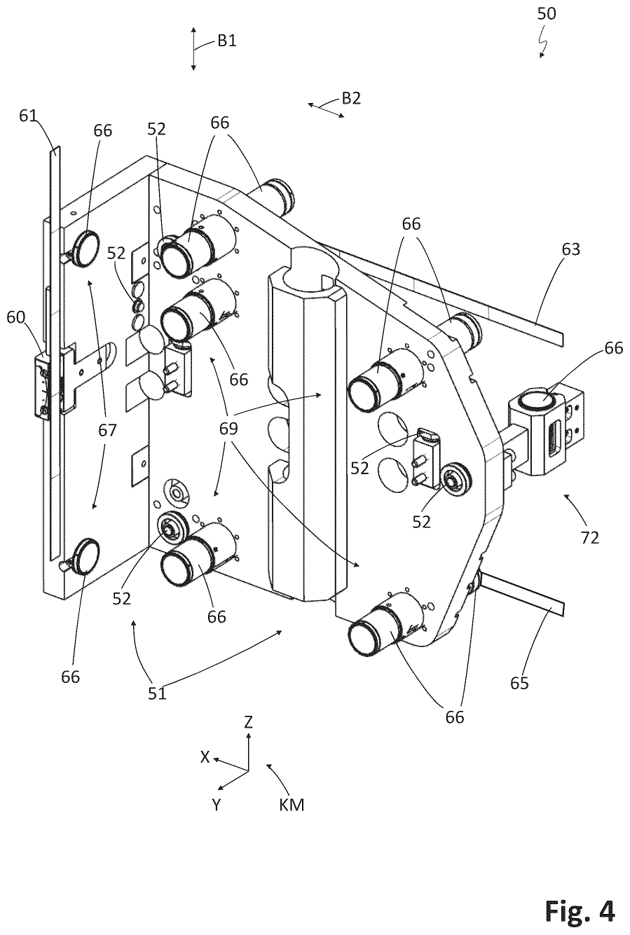

As apparent from FIG. 4, the support units 52 of support arrangement 51 are grouped. Within one group, all of the support units 52 have straight lines G that are orientated parallel to one another, wherein the support positions 53 are preferably arranged in two planes that are parallel to each other. In the first group—comprising three support units 52, according to the example—the straight lines G extend in Y-direction. In a second group—comprising two support units 52, according to the example—the straight lines G extend in Z-direction and in a third group-comprising one single support unit 52, according to the example—the straight lines or the straight line G extend or extends in X-direction. The number of support units 52 per group can also be distributed differently, wherein in total always exactly six support units are present, so that sensor support 50 is supported in a statically determined manner, however not overdetermined, on first positioning body 40.

Each of the support units 52 of support arrangement 51 forms a fixed support in support direction A and a floating support in all directions orthogonal to the support direction A. The sensor support 50 is supported in a floating manner by means of each support unit 52 on first positioning body 40. In case of torsions or deformations of first positioning body 40, these deformations are not transmitted to the sensor support 50, but rather, due to the support of sensor support 50, also in case of a torsion or deformation of first positioning body 40, a defined movement of sensor support 50 in one or more degrees of freedom results. The sensor support 50 is therefore always stressless and free of deformations, even in case of external influences, particularly thermal influences.

For determination of the measurement value W it is necessary to know the relative position between workpiece 23 and the workpiece measuring unit 25 configured for probing or measurement detection. On sensor support 50, therefore, multiple sensors are arranged in order to determine the position of the at least one workpiece measuring unit 25 in the machine coordinate system KM. For this purpose, one position sensor respectively is assigned to each of the machine axis 30 to 32, by means of which the at least one workpiece measuring unit can be positioned.

According to the example, a first position sensor 60 is present that is configured to detect a movement and/or a position of sensor support 50 in the first movement degree of freedom B1. The first position sensor 60 provides a respective first position signal P1 to the control device 35 (FIGS. 1, 4 and 5).

In the embodiment the first position sensor 60 cooperates with first scale 61 that is immovably arranged relative to the machine coordinate system KM, for example immovably connected with first guide 41.

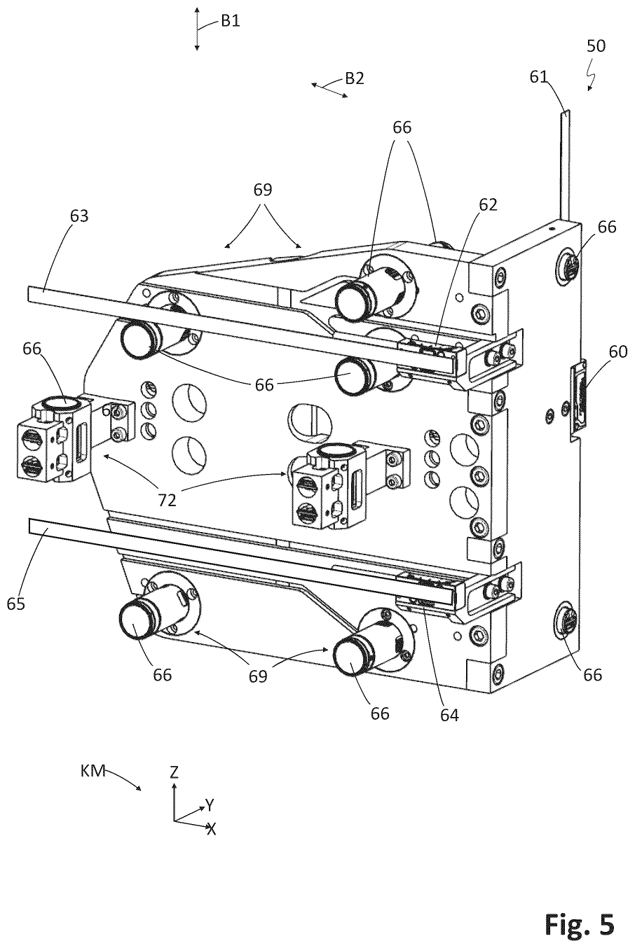

The second machine axis 31 comprises a second position sensor 62 that is arranged on sensor support 50 and configured to detect a movement and/or a position of second positioning body 42 in the second movement degree of freedom B2. For this purpose, the second position sensor 62 can cooperate, for example, with a second scale 63, which is immovably arranged on second positioning body 42 (FIG. 5).

A third position sensor 64 is arranged on sensor support 50 and is assigned to third positioning body 44. The third position sensor 64 is configured to detect a movement and/or a position of third positioning body 44 in the second movement degree of freedom B2. For this purpose, it can cooperate with a third scale 65 that is immovably arranged relative to third positioning body 44 on third positioning body 44 (FIG. 5).

The second position sensor 62 provides a second position signal P2 and the third position sensor 64 provides a third position signal P3 for control device 35 (FIG. 1). By means of first position signal P1 and second position signal P2, therefore the position of second positioning body 42 and by means of first position signal P1 and third position signal P3, the position of third positioning body 44 can be determined in the machine coordinate system KM.

The position sensors 60, 62, 64 operate preferably contactless with a respectively assigned scale 61 or 63 or 65, for example optically and/or electromagnetically, in order to detect a relative movement or a position in the respective movement degree of freedom B1 or B2.

For increasing the accuracy of the position determination in the embodiment, sensor support 50 comprises at least one reference sensor group having at least one reference sensor 66 respectively. Each reference sensor 66 is preferably configured as distance sensor, for example as distance sensor measuring in a capacitive manner. The at least one reference sensor 66 is configured to detect a distance and/or a distance change between reference sensor 66 and an assigned measurement surface 75. This measurement surface 75 can be a reference surface arranged immovably in the machine coordinate system KM or a datum surface immovably arranged on a positioning body 40, 42, 44, as explained in more detail below. Preferably, each measurement surface 75 is a surface that is planar in one or two spatial directions. Each measurement surface 75 can be orientated orthogonal to one of the directions X, Y, Z of machine coordinate system KM.

In the embodiment illustrated here, a first reference sensor group 67 having at least one reference sensor 66 is arranged on sensor support 50. The first reference sensor group 67 comprises two reference sensors 66 according to the example that are arranged with distance to one another in direction of the first movement degree of freedom B1 (here: Z-direction). Here, the two reference sensors 66 of first reference sensor group 67 are arranged along a straight line that extends parallel to the first movement degree of freedom B1. Alternatively, they could not only be offset to one another in direction of the first movement degree of freedom B1, but in addition also offset to each other orthogonal thereto, for example in Y-direction of machine coordinate system KM.

The reference sensors 66 of first reference sensor group 67 are configured to detect a distance and/or a distance change relative to first reference surface 68. The first reference surface 68 can be directly or indirectly immovably arranged on first guide 41, for example on guide column 39.

The first reference plane 68 is schematically apparent from FIG. 3. In the embodiment it is arranged in a common plane with first scale 61, wherein this plane is orientated parallel to the first movement degree of freedom B1 and orthogonal to the second movement degree of freedom B2, according to the example.

Further, a second reference sensor group 69 is arranged on sensor support 50 that comprises multiple reference sensors 66 for each positioning body 42, 44 that is present and movable in the second movement degree of freedom B2, for example, two or three reference sensors 66 in each case. Each reference sensor 66 of second reference sensor group 69 is configured to detect the distance and/or a distance change of sensor support 50 relative to a second reference surface 70 and/or a first datum surface 71. According to the example, the reference sensors 66 of second reference sensor group 69 are configured as tandem sensors, so that they detect a distance or a distance change to the second reference surface 70 as well as to the first datum surface 71.

In the embodiment second reference surface 70 is immovably directly or indirectly arranged on first guide 41 and can be provided on guide column 39, for example (FIGS. 2 and 3).

The first reference surface 68 extends parallel to the first movement degree of freedom B1 and orthogonal to the second movement degree of freedom B2. It is orientated orthogonal to the X-direction of the machine coordinate system KM according to the example.

Alternatively, first reference surface 68 and/or second reference surface 70 could be arranged on a reference body. The reference body can be arranged on machine base 21 and arranged with distance to guide column 39. In order to avoid oscillations, the reference body can be supported at least at one support position in an oscillation damping manner on guide column 39 additionally, for example by means of an elastically deformable damping element.

Each additional positioning body 42, 44 that is moveably supported on first positioning body 40 comprises one first datum surface 71 according to the example. This first datum surface 71 is at least in case of an ideal position and orientation of second positioning body 42 or third positioning body 44 orientated parallel to the second reference surface 70.

In addition, a third reference sensor group 72 is arranged on sensor support 50 that comprises multiple reference sensors and according to the example two reference sensor 66. The reference sensors 66 of third reference sensor group 72 are configured to detect a distance and/or distance change of sensor support 50 to a second datum surface 73 and/or a third datum surface 74 respectively. In case of an ideal orientation, the second datum surface 72 and the third datum surface 74 are orientated parallel to second movement degree of freedom B2 and particularly orthogonal to first movement degree of freedom B1.

It has to be noted here that datum surfaces 71, 73, 74 are located on a positioning body and, according to the example, on second positioning body 42 or on third positioning body 44 respectively. The orientation of datum surfaces 71, 73, 74 can thus be influenced due to thermal or other external influences that influence, for example, second guide 43 or third guide 45. The mentioned orientation of the datum surfaces 71, 73, 74 relative to machine coordinate system KM refers always to the ideal case or the desired set point orientation of these datum surfaces 71, 73, 74. If one of the positioning bodies 42, 44 tilts around one or more axes due to an external influence, thereby also the orientation of the concerned datum surfaces 71, 73, 74 changes in the machine coordinate system KM and thus deviates from the ideal orientation. This can be detected by means of the assigned reference sensor 66.

If a reference sensor group 67, 69, 72 comprises multiple reference sensors 66 assigned to a common measurement surface 75 (reference surface or datum surface) also tilting movements of sensor support 50 relative to this measurement surface 75 around one or more axes extending parallel to the respective measurement surface 75 can be detected. For example, by means of the two reference sensors 66 of first reference sensor group 67, a tilting movement of sensor support 50 around Y-direction can be detected.

Within the second reference sensor group 69, multiple reference sensors 66 are assigned to first datum surface 71 on second positioning body 42 and multiple other reference sensors 66 are assigned to first datum surface 71 on third positioning body 44, wherein all reference sensors 66 of second reference sensor group 69 are in addition assigned to second reference surface 70. In total, second reference sensor group 69 comprises five reference sensors 66 in the embodiment, wherein three of them cooperate with first datum surface 71 of second positioning body 42 and two of them cooperate with first datum surface 71 of third positioning body 44. In doing so, it is possible to determine the distance and the orientation of sensor support 50 relative to second reference surface 70 and the distance and the orientation of the two first datum surfaces 71 relative to sensor support 50. Thereby a relation with regard to the distance and the orientation between the first datum surfaces 71 and the second reference surface 70 can be determined.

In the illustrated embodiment, by means of the three reference sensors 66 assigned to first datum surface 71 of second positioning body 42, a tilting movement around the X-direction as well as a tilting movement around the Z-direction can be detected. Reference sensors 66 offset relative to one another in X-direction are assigned to first datum surface 71 of third positioning body 44, which can detect a tilting movement of first datum surface 71 of third positioning body 44 around the Z-direction. The second reference sensor group 69 comprises preferably two reference sensors 66 for each assigned first datum surface 71 respectively that are arranged in at least one spatial direction of machine coordinate system KM offset from one another or comprises three reference sensors 66 that are arranged offset relative to one another in two spatial directions of machine coordinate system KM (for example, in a triangular arrangement).

In the third reference sensor group 72, two reference sensors 66 are present according to the example that are arranged with distance in X-direction, that is in direction of second movement degree of freedom B2. By means of these reference sensors 66 of third reference sensor group 72, therefore the distance between the second datum surface 73 and the third datum surface 74, and thus between second positioning body 42 and third positioning body 44, can be determined as well as a tilting movement of these datum surfaces 73, 74 around the Y-direction.

Each reference sensor 66 transmits a reference sensor signal Rj(j=1, 2, 3, . . . m) to control device 35, characterizing the respectively measured distance or the respectively measured distance change (FIG. 1).

The control device 35 is configured to determine the measurement value W based on the measurement signal M, the position signals P1 to P3 as well as the reference sensor signals Rj. Thereby position signals P1 to P3 can be corrected based on the reference sensor signals Rj in order to allow a more accurate determination of the position of the workpiece measuring unit 25 in the machine coordinate system KM.

The reference sensor 66 and the position sensor or position sensors 60, 62, 64 assigned to a common direction in the machine coordinate system KM measure in a common plane, according to the example. For this purpose, for example, first scale 61 and first reference surface 68 are arranged in a common plane. Additionally or alternatively, second scale 63 and first datum surface 71 on second positioning body 42 are arranged in a common plane. Additionally or alternatively, third scale 65 and first datum surface 71 on third positioning body 44 are arranged in a common plane.

In addition, a plane in which second datum surface 73 extends or a plane in which third datum surface 74 extends can be a symmetry plane that extends centrally through first position sensor 60 (compare FIG. 2). A plane in which first reference plane 68 extends preferably forms a symmetry plane that extends centrally through second position sensor 62 as well as third position sensor 64 (compare FIG. 3).

Each reference sensor 66 comprises at least one sensor element 77. Each sensor element 77 has a sensor surface 78 facing a respectively assigned measurement surface 75 and is arranged opposite thereto with low distance. According to the example reference sensor 66 of first reference sensor group 67 have exactly one sensor element 77 that cooperates with the assigned first reference surface 68.

A reference sensor 66 can also have two separate sensor elements 77. In the embodiment, all reference sensors 66 of second reference sensor group 69 and third reference sensor group 72 have two sensor elements 77 that are assigned to different measurement surfaces 75 (reference surface or datum surface).

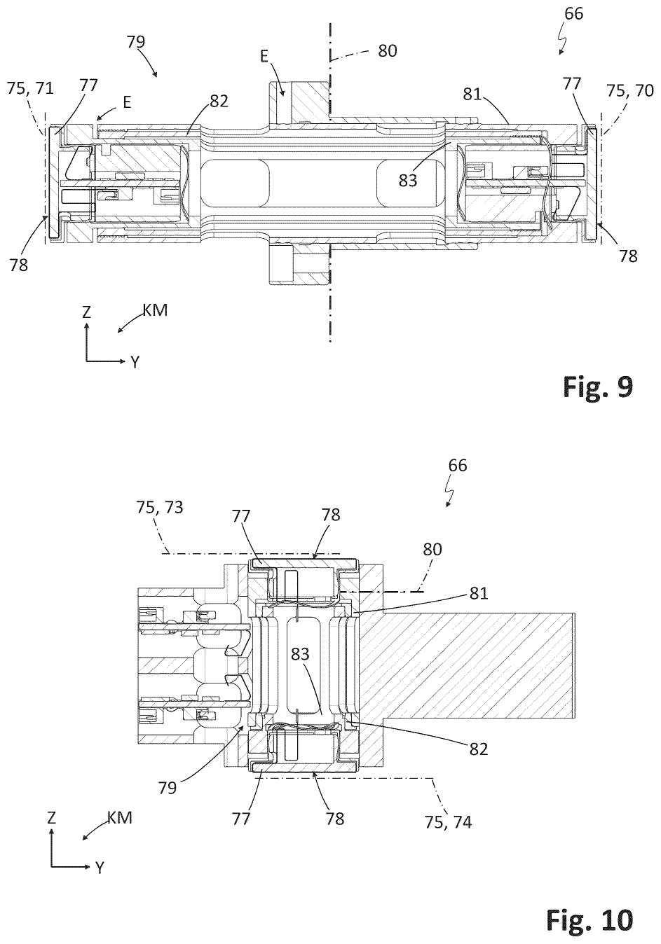

An embodiment for a reference sensor 66 of second reference sensor group 69 is depicted in FIG. 9 and an embodiment for a reference sensor 66 of third reference sensor group 72 is depicted in FIG. 10. These reference sensors 66 have a sensor housing 79, respectively, that is attached to sensor support 50 at an attachment position 80. Particularly, sensor housing 79 is exclusively fixated at this single attachment position 80 on sensor support 50. Adjoining this attachment position 80, sensor housing 79 can be subject to a longitudinal expansion whereby the distance of sensor element 77 from attachment position 80 can change. This attachment position 80 is illustrated in FIGS. 9 and 10 by means of a dash-dotted plane.

Originating from the attachment position 80 up to an assigned measurement surface 75 (reference surface or datum surface) of one of the two sensor elements 77. The sensor housing 79 has a thermal longitudinal expansion that substantially corresponds to the thermal longitudinal expansion of sensor support 50 and the components of measuring machine adjoining thereto (for example component of guide 41, 43, 45 or another part connected therewith), so that the longitudinal expansions are substantially completely balanced.

With reference to FIG. 10, for example the longitudinal expansion in Z-direction between the attachment position 80 of the reference sensors 66 of third reference sensor group 72 and the second datum surface 73 is substantially defined by the support units 52, the straight line G of which extend in Z-direction and that support the sensor support 50 in Z-direction. The support units 52 consist, for example of steel or a steel alloy and have a respective longitudinal expansion coefficient. Like the support units 52 the sensor housing 79 of each reference sensor 66 of third reference sensor group 72 is also made of steel or the steel alloy between the attachment position 80 and the sensor element 77 assigned to the second datum surface 73, so that the amount of the longitudinal expansion from the attachment position 80 up to the sensor element 77 has an equal absolute value. If the material expands due to heating, the distance between the two support positions 53 increases, whereby the distance between the attachment position 80 and the second datum surface 73 is increased. To the same extent the sensor housing 79 expands from the attachment position 80 to sensor element 77 assigned to the second datum surface 73, so that the thermal longitudinal expansions in Z-direction with regard to the second datum surface 73 is compensated.

The same applies to the reference sensor 66 of first reference sensor group 67, the sensor housing 79 of which consists between an attachment position 80 and the (single) sensor element 77 substantially of the same steel or the same steel alloy as support unit 52, supporting sensor support 50 in X-direction on first positioning body 40.

In the embodiment of reference sensor 66 of second reference sensor group 69, illustrated in FIG. 9, the longitudinal expansion between attachment position 80 and second reference surface 70 corresponds to the material(s) from which the sensor support 50, the first positioning body 40 as well as the first guide 41 consists that adjoin one another between attachment position 80 and the second reference surface 70. In the embodiment these materials can be, for example, steel or a steel alloy for first guide 41 and aluminum or an aluminum alloy for sensor support 50 and at least parts of first positioning body 40. The sensor housing 79 of reference sensor 66 of second reference sensor group 69 is built between attachment position 80 and sensor element 77 assigned to second reference surface 70 from a material that has the same thermal expansion coefficient as the material combination of sensor support 50, first positioning body 40 and first guide 41 between attachment position 80 and the second reference surface 70. Here in corresponding ratio the same materials can be used and the sensor housing 79 can be similarly built from a combination of aluminum or aluminum alloy and steel or steel alloy. Due to a thermal expansion, the distance between attachment position 80 and second reference surface 70 increases, whereby sensor housing 79 is expanded between attachment position 80 and sensor element 77 with equal amount so that the relative position between second reference surface 70 and the sensor element 77 cooperating therewith remains unchanged independent from thermal influences, at least substantially.

In the embodiments of reference sensors 66 according to FIGS. 9 and 10, sensor housing 79 comprises in addition multiple housing parts and according to the example, three housing parts 81, 82, 83 respectively that are movably or slidably connected with each other that they can be subject to a thermal length change relative to one another. The housing parts 81, 82, 83 can be tube or sleeve-shaped. For example, they can be arranged co-axially to one another. Alternatively to this, they could also be arranged and/or connected with one another in a different manner so that they compensate thermal influences to a major extent or entirely.

The principle of this stacked configuration of housing parts 81, 82, 83 is highly schematically and only for sake of illustration of the function principle illustrated in FIG. 8. In FIG. 8 aluminum or an aluminum alloy as material for a housing part is symbolized by a cross-hatched surface and steel or a steel alloy for a housing part is symbolized by a dotted filled surface schematically. It thereby applies that the thermal expansion coefficient of aluminum or the aluminum alloy is twice the thermal expansion coefficient of steel or steel alloy. Instead of aluminum and steel, also other material combinations could be used, the thermal expansion coefficients of which have substantially the ratio of 2:1.

On an outer housing part 81 one of the sensor elements 77 is attached to one end. The end arranged opposite in extension direction of this outer housing part 81 is immovably connected at a first connection position 84 with an adjacent end of a middle housing part 82. On the opposite side in extension direction of the middle housing part 82 at a second connection position 85 the middle housing part 82 is immovably connected with an inner housing part 83. Starting from this second connection position 85 the inner housing part 83 extends to an opposite end on which the respectively other sensor element 77 of reference sensor 66 is attached. The three housing parts 81, 82, 83 are only connected with one another at the two connection positions 84, 85 and can apart therefrom elongate or shorten relative to one another, due to thermal influences and can be moved relative to one another in pairs in a telescope-like manner so-to-speak.

The middle housing part 82 has a thermal expansion coefficient that is approximately twice the thermal expansion coefficient of the outer housing part 81 and the inner housing part 83. Thermal influences are thus at least substantially compensated by means of the three housing parts 81, 82, 83, so that the total length L of reference sensor 66 from sensor surface 78 of one sensor element 77 to the sensor surface 78 of the respective other sensor element 77 does not change or only to a minor extent due to thermal influences.

The principle explained based on FIG. 8 can be used for all reference sensors 66 that have two sensor elements 77.

Optionally, at least one damping element can be arranged in a gap and/or an opening between two parts of sensor housing 79 that can be moved relative to one another, for example for damping of the relative movement of two housing parts 81, 82, 83 respectively. For example, a pourable damping material can be inserted in a gap and/or opening and can be cured. The cured damping material or the damping element allows a relative movement of the two concerned housing parts 81, 82, 83 relative to one another, however, provides for an elastic damping. For example, the damping material or damping element can consist of silicone. For example, the at least one damping element and/or damping material E can be arranged at the locations indicated in FIGS. 9 and 10. Additionally or alternatively, the at least one damping element and/or damping material E can also be arranged or inserted at one or more other positions. The sensor housing 79 can have openings accessible from outside for this purpose.

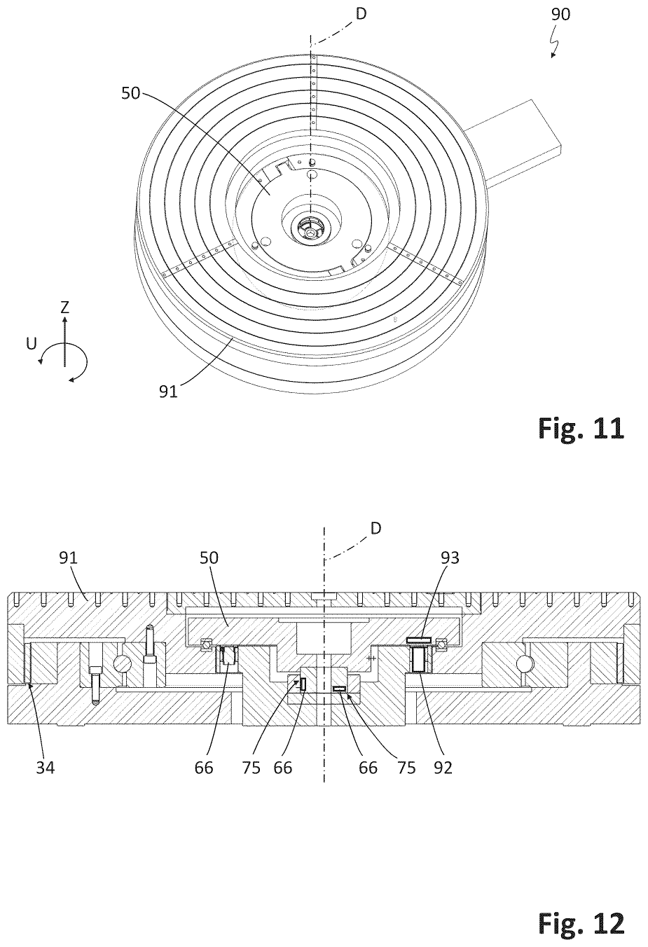

In the embodiments described so far the movement degrees of freedom B1, B2 are translational degrees of freedom. One of the movement degrees of freedom and, for example the first movement degree of freedom B1 can also be a rotational degree of freedom. This can be explained based on an example of a machine axis configured as rotation machine axis 90 of measuring machine 20, as illustrated based on FIGS. 11-14. Such a rotation machine axis 90 can be used for movement and positioning of workpiece holder 22 and/or for movement and positioning of a workpiece measuring unit 25 in measuring machine 20.

The rotation machine axis 90 has a positioning body 91 that can be rotatingly driven in a circumferential direction U around a rotation axis D, wherein the positioning body 91 can be configured in a ring-shaped or plate-shaped manner, for example. The positioning body 91 can also have any other arbitrary geometric form. It does not necessarily have a continuous closed shape in circumferential direction U around rotation axis D.

In the embodiment the positioning body 91 is driven by an assigned axis drive 34 that can be configured as direct drive, for example (FIG. 12).

The rotation machine axis 90 has a position sensor that can be denoted as rotation position sensor 92. The rotation position sensor 92 is configured to detect a movement and/or a position of positioning body 91 in circumferential direction U around rotation axis D. For example, for this purpose, it can cooperate with a ring-shaped ring scale 93, extending in a ring-shaped manner around rotation axis D, wherein ring scale 93 can be connected with positioning body 91 of rotation machine axis 90 in a torque-proof manner, for example (FIG. 12). The rotation position sensor 92 provides a rotation position signal that can be transmitted to control device 35 analog to the other position signals P1 to P3 (FIG. 12). The ring scale 93 can be orientated radially and/or axially relative to rotation axis D. The rotation position sensor 92 can thus be arranged radially adjacent or also axially adjacent to sensor support 50, depending on the configuration of rotation machine axis 90 and the available installation spaces.

By means of support arrangement 51, again comprising six individual support units 52, sensor support 50 is exactly statically determined supported on positioning body 91. The sensor support 50 is in this embodiment circular-shaped or ring-shaped and concentrically or coaxially arranged relative to rotation axis D. The support arrangement 51 is also in this embodiment configured analog to the embodiments of measuring machine 20 described so far.

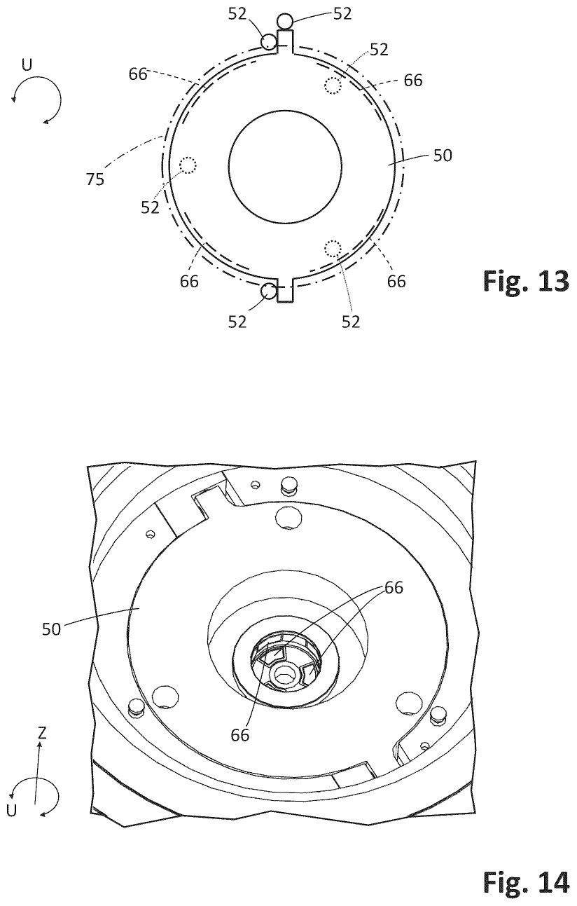

The sensor support 50 and the support arrangement 51 are schematically illustrated in FIG. 13. By means of three support units 52, sensor support 50 is supported in a direction parallel to rotation axis D. At two positions that are approximately diametrically opposite to one another, the sensor support 50 is supported in circumferential direction U or tangentially to the circumferential direction U by means of one support unit 52 respectively. At one position, sensor support 50 is supported in a direction orthogonal or radial to rotation axis D by means of one single support unit 52. The relative position of sensor support 50 relative to positioning body 91 of rotation machine axis 90 is thus statically determined, however, not overdetermined. The support units 52 of support arrangement 51 have a configuration, as illustrated in FIG. 7, so that reference can be made to the description above.

Multiple reference sensors 66 are present on sensor support 50, wherein at least one reference sensor 66 cooperates radial to rotation axis D with an assigned first measurement surface 75 enclosing rotation axis D in ring-shaped manner, wherein first measurement surface 75 can be a reference surface that is immovable in the machine coordinate system KM or can be a datum surface on another movable positioning body.

Further, at least one reference sensor 66 measuring in axial direction is arranged on sensor support 50, wherein the reference sensor 66 cooperates with an adjacent second measurement surface 75 that can be a reference surface immovable in the machine coordinate system KM or a datum surface arranged on a movable positioning body.

In the embodiment illustrated here, at least three reference sensors 66 measuring in axial direction and at least three or four reference sensors 66 measuring in radial direction are provided. By means of the axially measuring reference sensor 66 wobble errors can be detected and by means of the radially measuring reference sensor 66 eccentric errors can be detected during movement of positioning body 91 around rotation axis D.

The invention refers to a measuring machine 20 having at least one translational or rotational machine axis in order to move and/or position a workpiece holder 22 and a workpiece measuring unit 25 of measuring machine 20 relative to one another. The at least one machine axis has, for this purpose, a positioning body 40, 42, 44, 91 supported on an assigned guide in a translational or rotational movement degree of freedom B1, B2, wherein a sensor support 50 is supported on the positioning body 40, 42, 44, 91 by means of a support arrangement 51. The support arrangement 51 is configured to provide a statically determined support of sensor support 50 on positioning body 40, 91 and concurrently provide a tensionless support. In this manner it is avoided that torsions or other deformations of positioning body 40, 91 also occur to the sensor support 50, workpiece holder 22 and workpiece measuring unit 25.

### LIST OF REFERENCE SIGNS

20 measuring machine
21 machine base
22 workpiece holder
23 workpiece
24 rotary table
25 workpiece measuring unit
26 probe
27 optical measurement device
30 first machine axis
31 second machine axis
32 third machine axis
33 fourth machine axis
34 axis drive
35 control device
39 guide column
40 first positioning body
41 first guide
42 second positioning body
43 second guide
44 third positioning body
45 third guide
50 sensor support
51 support arrangement
52 support unit
53 support position
54 rolling element
55 support surface
56 support sleeve
60 first position sensor
61 first scale
62 second position sensor
63 second scale
64 third position sensor
65 third scale
66 reference sensor
67 first reference sensor group
68 first reference surface
69 second reference sensor group
70 second reference surface
71 first datum surface
72 third reference sensor group
73 second datum surface
74 third datum surface
75 measurement surface
77 sensor element
78 sensor surface
79 sensor housing
80 attachment position
81 outer housing part
82 middle housing part
83 inner housing part
84 first connection position
85 second connection position
90 rotating machine axis
91 positioning body of rotating machine axis
92 rotating position sensor
93 ring scale
A support direction
B1 first movement degree of freedom
B2 second movement degree of freedom
D rotation axis
E damping material
G straight line
KM machine coordinate system
L length of reference sensor
M measurement signal
P1 first position signal
P2 second position signal
P3 third position signal
Rj reference sensor signal
Si control signal
U circumferential direction
W measurement value
X X-direction
Y Y-direction
Z Z-direction

1. A measuring machine (20), comprising:
at least one machine axis (30, 31, 32), wherein the at least one machine axis (30, 31, 32) comprises a first machine axis (30) comprising a first positioning body (40), which is movably supported along a respectively assigned first guide (41) in a first translational or rotational movement degree of freedom (B1) and is configured to be positioned in the first translational or rotational movement degree of freedom (B1);
a workpiece holder(22) that is configured to hold a workpiece (23) and a workpiece measuring unit (25), wherein the workpiece measuring unit (25) is configured to produce at least one measurement signal (M) by probing of the workpiece (23) in a contacting or contactless manner, wherein the workpiece holder (22) and the workpiece measuring unit (25) are configured to be moved and/or positioned relative to one another via the first machine axis (30);
a sensor support (50);
a support arrangement (51) configured as a floating bearing by means of which the sensor support (50) is supported on the first positioning body (40); and
a first position sensor (60) arranged on the sensor support (50), wherein the first position sensor (60) is configured to detect a movement and/or a position of the sensor support (50) in the first translational or rotational movement degree of freedom (B1).

2. The measuring machine according to claim 1, comprising a machine base (21) that defines a machine coordinate system (KM).

3. The measuring machine according to claim 2, further comprising at least one reference sensor (66) arranged on the sensor support (50), wherein the at least one reference sensor (66) is configured to detect a distance or a distance change of the sensor support (50) to a measurement surface (75), wherein the measurement surface (75) is one of a reference surface (68, 70) that is immovable relative to the machine coordinate system (KM) and a datum surface (70, 71, 73) on a positioning body (42, 44) that is movable relative to the machine coordinate system (KM).

4. The measuring machine according to claim 3, further comprising a first reference sensor group (67) having at least one reference sensor (66) arranged on the sensor support (50), wherein the at least one reference sensor (66) of the first reference sensor group (67) is configured to detect a distance and/or a distance change of the sensor support (50) to a first reference surface (68) which is parallel to the first translational or rotational movement degree of freedom (B1).

5. The measuring machine according to claim 4, further comprising a first scale (61) extending in a direction of the first translational or rotational movement degree of freedom (B1), wherein the first scale (61) is immovably arranged relative to the machine coordinate system (KM) and/or to the first guide (41) and is configured for cooperation with the first position sensor (60), wherein the first scale (61) and the first reference surface (68) are arranged in a common plane, in parallel planes offset to one another, or in planes that are oriented orthogonal to one another.

6. The measuring machine according to claim 4, further comprising a second reference sensor group (69) having at least one reference sensor (66) arranged on the sensor support (50), wherein the at least one reference sensor (66) of the second reference sensor group (69) is configured to detect a distance and/or a distance change of the sensor support to a second reference surface (70), wherein the second reference surface (70) is oriented parallel to the first translational or rotational movement degree of freedom (B1) and is immovably arranged relative to the machine coordinate system (KM) and/or to the first guide (41), wherein the first reference surface (68) is oriented orthogonal to the second reference surface (70).

7. The measuring machine according to claim 6, further comprising:
a second machine axis (31) having a second guide (43) and a second positioning body (42) which is movably supported on the second guide (43) in a second translational or rotational movement degree of freedom (B2) different from the first translational or rotational degree of freedom and is configured to be positioned in the second translational or rotational movement degree of freedom (B2), wherein the second guide (43) is arranged on the first positioning body; and
a second position sensor (62) that is configured to detect a movement and/or a position of the second positioning body (42) in the second translational or rotational movement degree of freedom (B2).

8. The measuring machine according to claim 7, comprising:
a third machine axis (32) having a third guide (45) and a third positioning body (44) which is movably supported on the third guide (45) in the second translational or rotational movement degree of freedom (B2) parallel to the second positioning body (42) and is configured to be positioned in the second translational or rotational movement degree of freedom (B2), wherein the third guide (45) is arranged on the first positioning body (40); and
a third position sensor (65) that is configured to detect a movement and/or a position of the third positioning body (45) in the second translational or rotational movement degree of freedom (B2).

9. The measuring machine according to claim 8, wherein each reference sensor (66) of the second reference sensor group (69) is configured to detect a distance and/or distance change of the sensor support (50) to a first datum surface (71) on the second positioning body or the third positioning body (42, 44).

10. The measuring machine according to claim 9, comprising a second scale (63) extending parallel to the second translational or rotational movement degree of freedom (B2) on the second positioning body (42), wherein the second scale (63) is configured to cooperate with the second position sensor (62) and/or a third scale (65) extending parallel to the second translational or rotational movement degree of freedom (B2) on the third positioning body (44), wherein the third scale (65) is configured to cooperate with the third position sensor (64), wherein the first datum surface (71) and the second scale (63) and/or the third scale (65) are arranged in a common plane, in parallel planes offset to one another, or in planes that are oriented orthogonal to one another.

11. The measuring machine according to claim 10, further comprising a third reference sensor group (72) having at least one reference sensor (66) and being arranged on the sensor support (50), wherein each reference sensor (66) of the third reference sensor group (72) is configured to detect a distance and/or a distance change of the sensor support (50) to a second datum surface (73) arranged on the second positioning body (42) and/or a third datum surface (74) arranged on the third positioning body (44).

12. The measuring machine according to claim 11, wherein the at least one reference sensor (66) comprises at least one sensor element (77) arranged in a sensor housing (79), wherein the sensor housing (79) is attached to the sensor support (50) at an attachment position (80) and comprises a same thermal longitudinal expansion starting from the attachment position (80) up to a sensor surface (78) of the at least one of the sensor element (77) as a thermal longitudinal expansion of the sensor support (50) and/or at least one adjoining component of one of the first, second or third machine axes (30, 31, 32) from the attachment position (80) up to a measurement surface (75) to which this the at least one sensor element (77) is assigned.

13. The measuring machine according to claim 12, wherein the at least one reference sensor (66) of the first and/or second and/or third reference sensor group (67, 69, 72) comprises two sensor elements (77) arranged in a sensor housing (79), wherein the two sensor elements (77) have one sensor surface (78), respectively, which cooperates with different measurement surfaces (75), wherein the sensor housing (79) comprises a plurality of housing parts (80, 81, 82) that are movable relative to one another and comprise thermal longitudinal expansions which eliminate one another so that a distance between the sensor surfaces of the sensor elements (77) is substantially constant.

14. The measuring machine according to claim 3, comprising a control device (35) to which a measurement signal (M) of the workpiece measuring unit (25), at least one reference sensor signal (Rj) of a reference sensor (66) and at least one position signal (P1, P2, P3) of a position sensor (60, 62, 64) are provided, wherein the control device (35) is configured to determine a measurement value (W) and/or position value on the workpiece (23) therefrom.

15. The measuring machine according to any of the claim 3, wherein a measurement surface (75) based on which an assigned reference sensor (66) measures a distance and/or a distance change to the sensor support (50) in a spatial direction (X, Y, Z) of the machine coordinate system (KM) is positioned in a same plane together with a position sensor (60, 62, 64) which detects a position in a same spatial direction (X, Y, Z) of the machine coordinate system (KM).

16. The measuring machine according to claim 1, wherein the support arrangement (51) comprises a plurality of separate support units (52) for floating support of the sensor support (50) on the first positioning body (40), wherein each of the plurality of separate support units (52) comprises a rolling element (54) that abuts at a first support position (53) against a support surface (55) on the sensor support (50) and at a second support position (53) against a support surface (55) on the first positioning body (40).

17. The measuring machine according to claim 16, wherein each rolling element (54) is arranged in an elastically deformable support sleeve (56).

18. The measuring machine according to claim 17, wherein a static friction and/or a dynamic friction between the rolling element (54) and the elastically deformable support sleeve (56) is lower than a static rolling start resistance and/or a dynamic rolling resistance of the rolling element (54) between the first and second support positions (53).

19. The measuring machine according to claim 16, wherein individual ones of the plurality of separate multiple support units (52) comprise one support position (53) respectively, which are arranged in a common first plane which is oriented parallel to the first translational or rotational movement degree of freedom (B1).

20. The measuring machine according to claim 19, wherein individual ones of the plurality of separate support units (54) comprise one support position (53) respectively, that are arranged in a common second plane which is oriented orthogonal to the first translational or rotational movement degree of freedom (B1).

21. The measuring machine according to claim 20, wherein at least one support unit (54) of the plurality of separate support units comprises support positions (53) which are arranged on a straight line extending orthogonal to the common first plane or the common second plane.
